(19) United States
(12) Patent Application Publication
(10) Pub. No.: US 2022/0394956 A1
(43) Pub. Date: Dec. 15, 2022

(54) WEIGHT ESTIMATION SYSTEM, WEIGHT ESTIMATION METHOD, AND RECORDING MEDIUM

(71) Applicant: Panasonic Intellectual Property Management Co., Ltd., Osaka (JP)

(72) Inventors: Shingo NAGATOMO, Osaka (JP); Yuichi INABA, Osaka (JP); Mamoru OZAKI, Osaka (JP)

(21) Appl. No.: 17/618,912

(22) PCT Filed: Jul. 1, 2020
(86) PCT No.: PCT/JP2020/025762

§ 371 Date: Dec. 14, 2021

(30) Foreign Application Priority Data
Jul. 25, 2019 (JP) 2019-136685

(51) Int. Cl. A01K 29/00; G01G 17/08; G01G 9/00; G06V 40/20; G06T 7/11; G06V 10/22; A01K 45/00

(52) U.S. Cl. CPC A01K 29/005; G01G 17/08; G01G 9/00; G06V 40/20; G06T 7/11; G06V 10/22; A01K 45/00; G06V 10/70

(57) ABSTRACT

A weight estimation system includes: an image capturer that captures an image of an inside of a poultry house; a calculator that calculates a flocking behavior feature quantity of chickens in the poultry house by performing image processing on the image captured by the image capturer; and an estimator that estimates a weight for each chicken in the poultry house, based on the flocking behavior feature quantity calculated.

### TECHNICAL FIELD

The present invention relates to a weight estimation system that estimates a weight for each chicken in a poultry house.

### BACKGROUND ART

Livestock farming is an active industry in many countries of the world including Japan. Patent Literature (PTL) 1 discloses, as a technique relating to livestock farming, the system that can readily estimate various characteristic values of a cow body.

### CITATION LIST

[PTL 1] Japanese Unexamined Patent Application Publication No. 2016-059300

### SUMMARY OF INVENTION

### Technical Problem

Since a large number of chickens are simultaneously raised in poultry farming, a method for measuring a weight for each chicken leaves room for consideration.

The present invention relates to a weight estimation system, a weight estimation method, and a program which are capable of estimating a weight of a chicken in a poultry house.

### Solution to Problem

A weight estimation system according to an aspect of the present invention includes: an image capturer that captures an image of an inside of a poultry house; a calculator that calculates a flocking behavior feature quantity of chickens in the poultry house by performing image processing on the image captured by the image capturer; and an estimator that estimates a weight for each chicken in the poultry house, based on the flocking behavior feature quantity calculated.

A weight estimation method according to an aspect of the present invention includes: capturing an image of an inside of a poultry house; calculating a flocking behavior feature quantity of chickens in the poultry house by performing image processing on the image captured; and estimating a weight for each chicken in the poultry house, based on the flocking behavior feature quantity calculated.

A program according to an aspect of the present invention is a program for causing a computer to execute the weight estimation method.

### Advantageous Effects of Invention

A weight estimation system, a weight estimation method, and a program according to the present invention are capable of estimating a weight of a chicken in a poultry house.

### BRIEF DESCRIPTION OF DRAWINGS

FIG. 1 is a diagram illustrating an overview of a weight estimation system according to an embodiment.

FIG. 2 is a block diagram illustrating a functional configuration of the weight estimation system according to the embodiment.

FIG. 3 is a flowchart illustrating operation for calculating a density deviation.

FIG. 4 is a diagram illustrating an example of an image of an inside of a poultry house which is captured by an image capturer.

FIG. 5 is a diagram illustrating another example of an image of the inside of the poultry house which is captured by the image capturer.

FIG. 6 is a flowchart illustrating operation for calculating an amount of activity.

FIG. 7 is a diagram illustrating a relationship between flocking behavior feature quantities of chickens in the poultry house and feed consumption states of the chickens in the poultry house.

FIG. 8 is a diagram schematically illustrating a machine learning model used for estimating a weight for each chicken.

FIG. 9 is a flowchart illustrating operation for estimating a weight for each chicken.

FIG. 10 is a graph illustrating the progression of estimated values of weight increments for each chicken.

FIG. 11 is a diagram illustrating an example of a display of estimated values of weights for each chicken.

FIG. 12 is a diagram illustrating an example of a display of estimated values of weights for each chicken.

FIG. 13 is a diagram illustrating an overview of a weight estimation system according to a variation.

FIG. 14 is a diagram illustrating an example of an image of an inside of a poultry house which is captured by an image capturing device that functions as a fisheye camera.

FIG. 15 is a diagram illustrating an example of an image obtained by correcting the image of the inside of the poultry house which is captured by the imaging capturing device that functions as a fisheye camera.

### DESCRIPTION OF EMBODIMENTS

Hereinafter, embodiments will be described with reference to the drawings. Note that the embodiments below each describe a general or specific example. The numerical values, shapes, materials, elements, the arrangement and connection of the elements, steps, and orders of the steps, etc. presented in the embodiments below are mere examples, and are not intended to limit the present invention. Furthermore, among the elements in the embodiments below, those not recited in any one of the independent claims will be described as optional elements.

Note that the drawings are schematic diagrams, and do not necessarily provide strictly accurate illustration. Throughout the drawings, the same numeral is given to substantially the same element, and redundant description is omitted or simplified.

### Embodiment

### [Configuration]

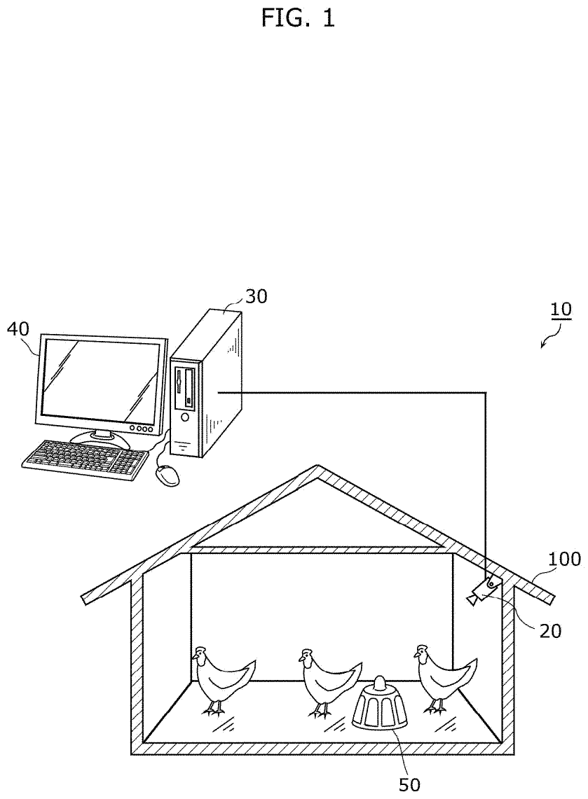

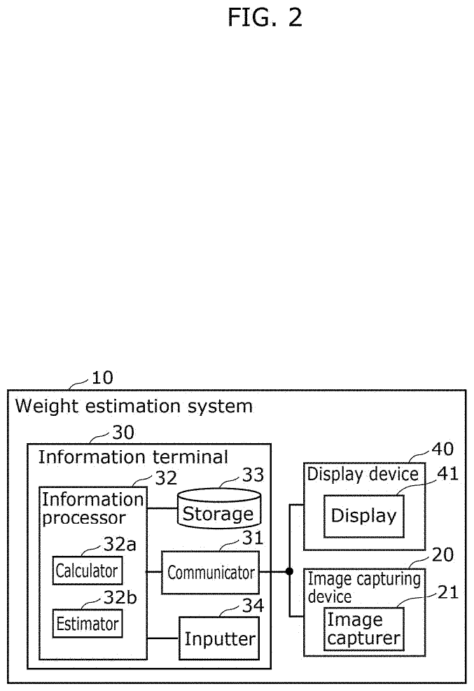

First, a configuration of a weight estimation system according to an embodiment will be described. FIG. 1 is a diagram illustrating an overview of a weight estimation system according to the embodiment. FIG. 2 is a block diagram illustrating a functional configuration of the weight estimation system according to the embodiment.

As illustrated in FIG. 1, weight estimation system 10 according to the embodiment is provided in, for example, poultry house 100. Chickens raised in poultry house 100 are broiler chickens (more specifically, Chunky, Cobb, Arbor Acres, etc.), but may be other breeds of chickens, such as the so-called locally produced chickens. Poultry house 100 is provided with feeders 50, waterers (not illustrated), etc.

Weight estimation system 10 calculates a flocking behavior feature quantity of chickens in poultry house 100 by performing image processing on an image of an inside of poultry house 100 which is captured by image capturing device 20, and estimates a weight for each chicken in poultry house 100 based on the calculated flocking behavior feature quantity. A flocking behavior feature quantity indicates a behavior of a plurality of chickens as a single flock. If the weight is estimated based on a flocking behavior feature quantity as described above, it is possible to understand the state of growth of chickens with reduced equipment spending, since a scale, etc. need not be introduced. Moreover, it is possible to simplify the work for weighing chickens (e.g., work for putting a chicken on a scale).

Specifically, weight estimation system 10 includes image capturing device 20, information terminal 30, and display device 40 as illustrated in FIG. 1 and FIG. 2. The following describes each device in detail.

### [Image Capturing Device]

Image capturing device 20 captures an image of an inside of poultry house 100. Image capturing device 20 is, for example, provided on a ceiling or on a wall of poultry house 100, and image capturer 21 captures, from above, an image of the entirety of the inside of poultry house 100. An image here means a still image. Image capturing device 20 constantly captures a moving image that includes, for example, a plurality of images (i.e., frames). Image capturing device 20 includes image capturer 21.

Image capturer 21 is an imaging module including an image sensor and an optical system (a lens, etc.) that guides light to the image sensor. The image sensor is specifically a complementary metal oxide semiconductor (CMOS) sensor, a charge-coupled device (CCD) sensor, etc. Information terminal 30 performs image processing on an image captured by image capturer 21 for monitoring the feed consumption state of chickens in poultry house 100.

### [Information Terminal]

Information terminal 30 is used by a manager etc. of poultry house 100. Information terminal 30 performs image processing on an image of the inside of poultry house 100 which is captured by image capturing device 20 for monitoring the feed consumption state of chickens in poultry house 100. Information terminal 30 is, for example, a personal computer, but may be a smartphone or a tablet terminal. Moreover, information terminal 30 may be a dedicated device used for weight estimation system 10. Specifically, information terminal 30 includes communicator 31, information processor 32, storage 33, and inputter 34.

Communicator 31 is an example of an obtainer. Communicator 31 obtains an image captured by image capturer 21 included in image capturing device 20. In addition, under the control of calculator 32a, communicator 31 transmits, to display device 40, image information for displaying an image showing that the feed consumption state is worsened.

Communicator 31 is specifically a communication module that performs wired or wireless communication. In other words, the communication module is a communication circuit. A communication method employed by communicator 31 is not particularly limited. Communicator 31 may include two types of communication modules for communicating with each of image capturing device 20 and display device 40. Moreover, a relay device, such as a router, may be interposed between communicator 31, and image capturing device 20 and display device 40.

Information processor 32 performs information processing for monitoring the feed consumption state of chickens in poultry house 100. Specifically, information processor 32 is implemented by a microcomputer, but may be implemented by a processor or a dedicated circuit. Information processor 32 may be implemented by a combination of at least two of a microcomputer, a processor, and a dedicated circuit. Specifically, information processor 32 includes calculator 32a and estimator 32b.

Calculator 32a calculates flocking behavior feature quantities of chickens in poultry house 100 which are obtained by processing images obtained by communicator 31. The flocking behavior feature quantities are, for example, a density deviation and an amount of activity. These flocking behavior feature quantities will be described later in detail.

Estimator 32b estimates a weight for each chicken in poultry house 100, based on the flocking behavior feature quantities calculated by calculator 32a. Note that a method for estimating a weight for each chicken which is employed by estimator 32b will be described later in detail.

Storage 33 stores a control program to be executed by information processor 32. Storage 33 is implemented by, for example, a semiconductor memory.

Inputter 34 is a user interface device that receives an input by a manager etc. of poultry house 100. Inputter 34 is implemented by, for example, a mouse and a keyboard. Inputter 34 may also be implemented by a touch panel etc.

### [Display Device]

Display device 40 notifies, by displaying an image, the feed consumption state of chickens in poultry house 100 to a manager etc. of poultry house 100. Display device 40 includes display 41. Display 41 displays an image based on image information transmitted from communicator 31. Display 41 is an example of a notifier, and notifies, by displaying an image, a manager etc. of poultry house 100 that the feed consumption state is worsened.

Specifically, display device 40 is, for example, a monitor for a personal computer, but may be a smartphone or a tablet terminal. When information terminal 30 is, for example, a smartphone, information terminal 30 may include display 41, instead of display device 40. Specifically, display 41 is implemented by a liquid crystal panel or an organic electroluminescent (EL) panel.

### [Operation for Calculating Density Deviation]

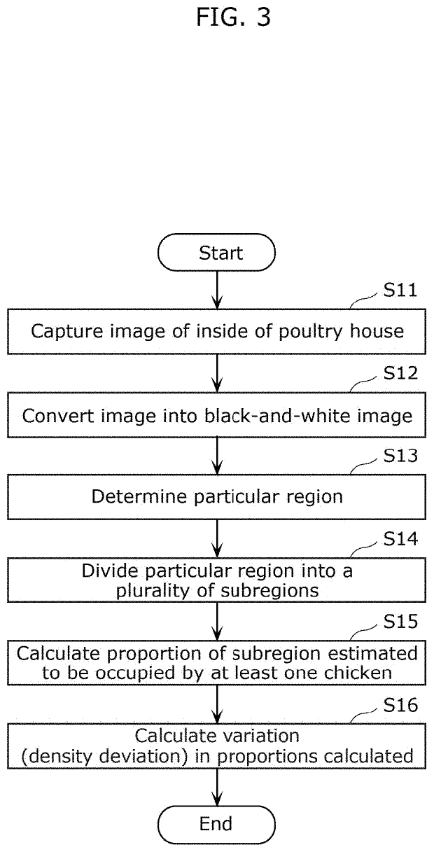

It is considered that the feed consumption state is favorable when chickens are crowded around feeder 50 in poultry house 100. Accordingly, weight estimation system 10 calculates a density deviation as a flocking behavior feature quantity indicating a crowding state of chickens around feeder 50. The following describes operation for calculating such a density deviation in detail. FIG. 3 is a flowchart illustrating operation for calculating a density deviation.

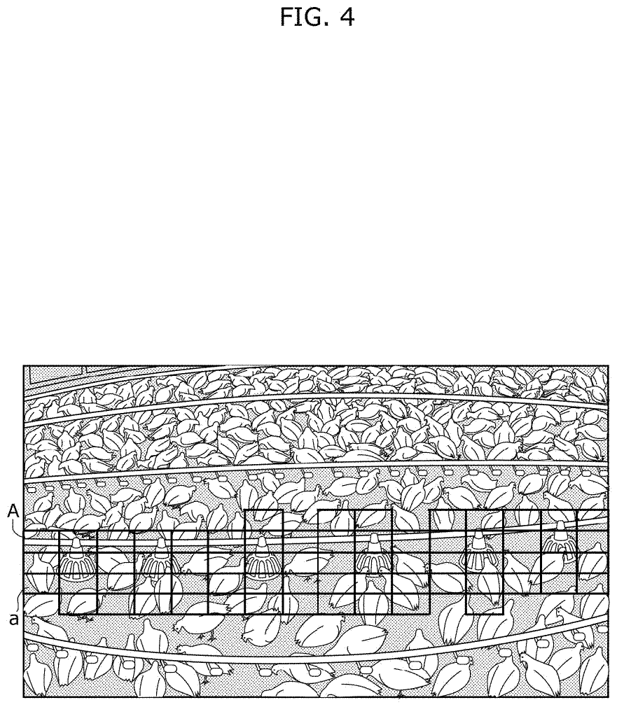

First, image capturer 21 of image capturing device 20 captures an image of an inside of poultry house 100 (S11). FIG. 4 is a diagram illustrating an example of an image of the inside of poultry house 100 which is captured by image capturer 21.

Next, calculator 32a of information terminal 30 obtains the image of the inside of poultry house 100 which is captured by image capturer 21, and converts the obtained image into a black-and-white image (S12). When the image captured by image capturer 21 is a color image, calculator 32a converts the obtained color image into a grayscale image, then converts the grayscale image into a binary image by comparing a pixel value of each of a plurality of pixels included in the gray scale image with a threshold. That is, calculator 32a converts the grayscale image into a black-and-white image. The black-and-white image is an image having a plurality of pixels each of which is either black or white. The black-and-white image is, in other words, an image which is captured by image capturer 21 and is converted into a binary image.

Since chickens have a white body, a white portion in the black-and-white image is a portion in which at least one chicken is estimated to be present. Since a determination of the crowding state of chickens around feeder 50 is the aim of the operation for calculating a density deviation, making a distinction between a portion in which at least one chicken is present and a portion in which no chicken is present increases accuracy of the determination of the crowding state. Accordingly, a threshold used for converting an image into a binary image is appropriately determined so that a portion in which at least one chicken is present is selectively determined to be white. Note that the P-tile method, the mode method, and the discriminant analysis method, etc. have been known as typical methods for calculating a threshold used for converting an image into a binary image, and the threshold may be determined using such methods. In addition, feeder 50, etc. placed inside poultry house 100 may have a color that is likely to be determined to be black when an image is converted into a binary image. That is, it is desirable that feeder 50 has a color different from the color of chickens.

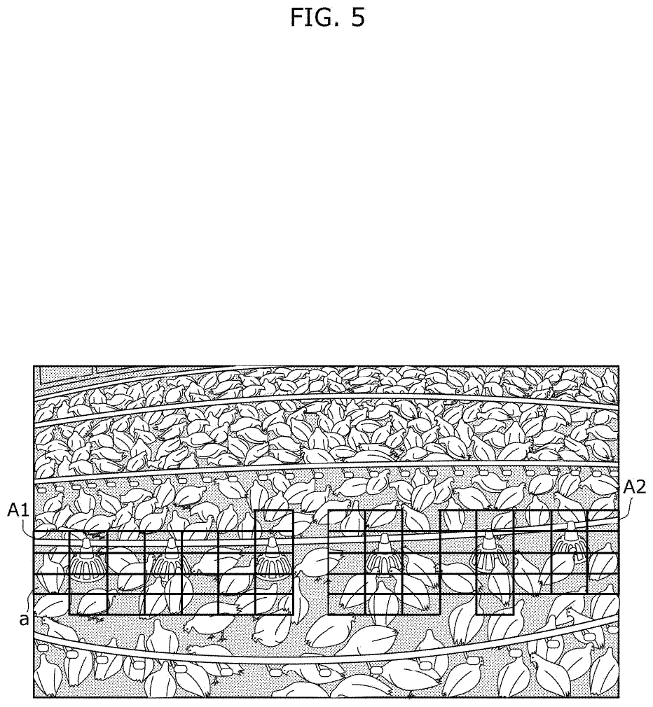

Next, calculator 32a determines a particular region that is at least part of the black-and-white image (S13). The particular region is, specifically, part of the black-and-white image, and includes a portion in which at least one feeder 50 is present. FIG. 4 exemplifies particular region A that is around feeders 50 and extends along the horizontal direction of the image. In FIG. 4, a region around feeders 50 is selectively determined to be particular region A. Note that a particular region may be divided into parts. FIG. 5 is a diagram illustrating an example of an image of the inside of poultry house 100 which is captured by image capturer 21, in the case where the particular region is divided into parts. FIG. 5 illustrates particular region A2, in addition to particular region A1. A determination as to which part of an image is to be a particular region is empirically or experimentally made by, for example, an installer etc. at the time of installation of image capturing device 20. When an area captured by image capturer 21 is small, the entirety of an image may be a particular region.

Next, calculator 32a divides the particular region into a plurality of subregions (S14). FIG. 4 (or FIG. 5) exemplifies a plurality of subregions a each in the shape of a quadrilateral which are obtained by dividing the particular region into a grid-shaped pattern. A method for dividing the particular region (the size of a subregion, the number of times that the particular region is divided, etc.) is empirically or experimentally determined by, for example, the installer, etc.

Next, calculator 32a calculates, for each of the plurality of subregions, the proportion of the subregion estimated to be occupied by at least one chicken (S15). Specifically, calculator 32a calculates, as the proportion of the subregion estimated to be occupied by at least one chicken, the proportion of the area size of a white portion in the entire subregion. More specifically, calculator 32a calculates the proportion of the area size of the white portion by dividing the total number of white pixels included in the subregion by the total number of pixels included in the entire subregion.

Next, calculator 32a calculates a variation in the calculated proportions of the subregions each of which is estimated to be occupied by at least one chicken (S16). In other words, calculator 32a determines a spatial variation in the density of chickens present in the particular region. The variation here is specifically a standard deviation, but may be a variance. The variation in the calculated proportions of the subregions each of which is estimated to be occupied by at least one chicken will also be indicated as a density deviation.

A state in which the density deviation is comparatively small means that the feed consumption state is favorable. According to experiments conducted by the inventors, a weight of a chicken can be efficiently increased by maintaining a state in which the density deviation is comparatively small.

### [Operation for Calculating Amount of Activity]

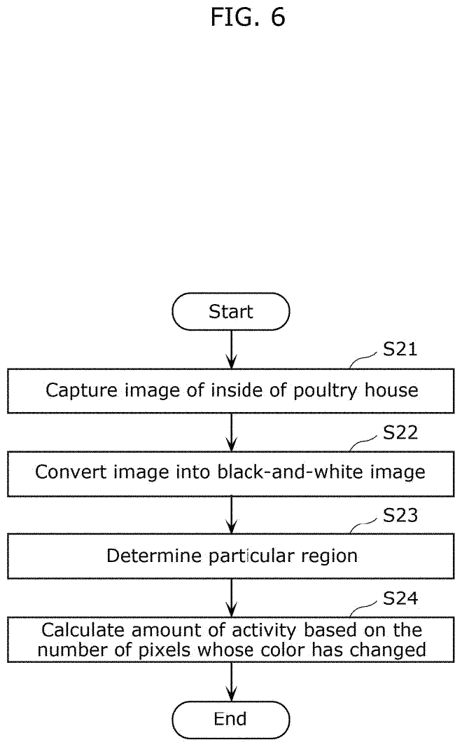

Furthermore, chickens active around feeder 50 are not only present around feeder 50, but are estimated to be consuming feed. Therefore, it is considered that the feed consumption state is more favorable as the amount of activity of the chickens around feeder 50 increases. Accordingly, weight estimation system 10 calculates, as another flocking behavior feature different from the density deviation, an amount of activity of chickens around feeder 50. Specifically, calculator 32a calculates an amount of activity of chickens in a particular region by performing image processing on images captured by image capturer 21. Hereinafter, such operation for calculating an amount of activity will be described in detail. FIG. 6 is a flowchart illustrating operation for calculating an amount of activity.

First, image capturer 21 of image capturing device 20 captures an image of an inside of poultry house 100 (S21). Calculator 32a of information terminal 30 converts the image of the inside of poultry house 100 which is captured by image capturer 21 into a black-and-white image (S22), and determines at least part of the black-and-white image to be a particular region (S23). These steps S21 through step S23 are the same as steps S11 through S13 shown in FIG. 3. The particular region determined in step S23 is the same as the particular region determined in step S13.

Next, calculator 32a calculates the amount of activity based on the number of pixels which are included in the particular region of the black-and-white image to be processed and whose color has changed from an image one frame prior to the black-and-white image to be processed (S24). Specifically, calculator 32a compares the black-and-white image to be processed with a black-and-white image one frame prior to the black-and-white image to be processed, and counts the number of pixels included in the particular region whose color has changed from the black-and-white image one frame prior to the black-and-white image to be processed. Here, pixels whose color has changed includes both (i) pixels whose color has changed from black to white and (ii) pixels whose color has changed from white to black. Calculator 32a then calculates the number of counted pixels as the amount of activity. Note that calculator 32a may calculate, as the amount of activity, the proportion of the number of counted pixels to the total number of pixels included in the particular region.

### [Relationship Between Flocking Behavior Feature Quantity and Feed Consumption State]

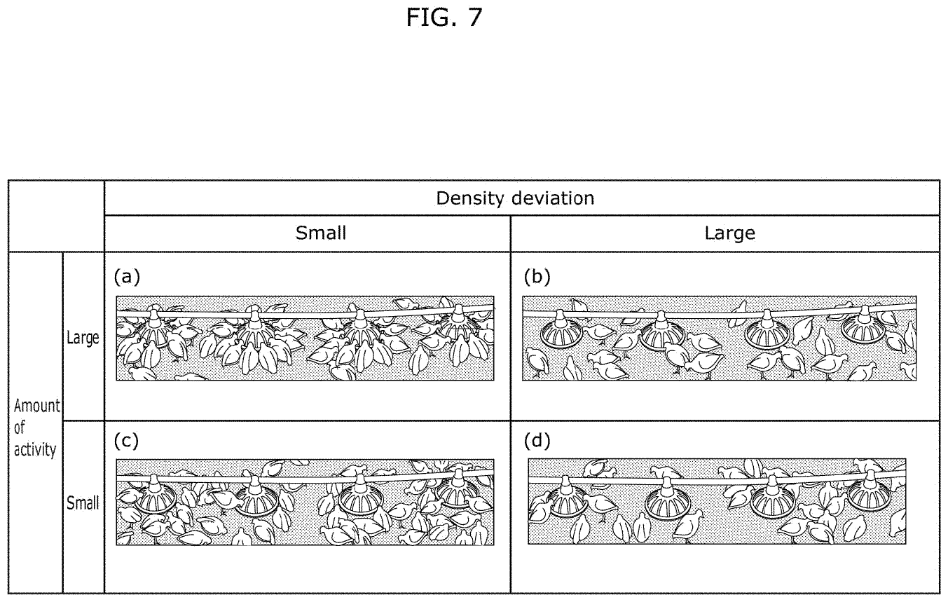

It can be said that a density deviation and an amount of activity each are a flocking behavior feature quantity that indicates a feed consumption state of chickens in poultry house 100. FIG. 7 is a diagram illustrating a relationship between flocking behavior feature quantities of chickens in poultry house 100 and feed consumption states of the chickens in poultry house 100.

As illustrated in (a) of FIG. 7, the feed consumption state is favorable when the chickens are active and uniformly distributed around feeders 50. In such a case, the density deviation is small, and the amount of activity is large.

As illustrated in (b) of FIG. 7, the feed consumption state is not so favorable when the chickens are dispersed and moving around feeders 50. In such a case, the density deviation is large, and the amount of activity is large.

As illustrated in (c) of FIG. 7, the feed consumption state is not so favorable when a certain number of the chickens are crowded around feeders 50, but many of the chickens are sleeping. In such a case, the density deviation is small, and the amount of activity is small.

As illustrated in (d) of FIG. 7, the feed consumption state is unfavorable when the chickens are not crowded around feeders 50 and the chickens are dispersed and sleeping in poultry house 100. In such a case, the density deviation is large, and the amount of activity is small.

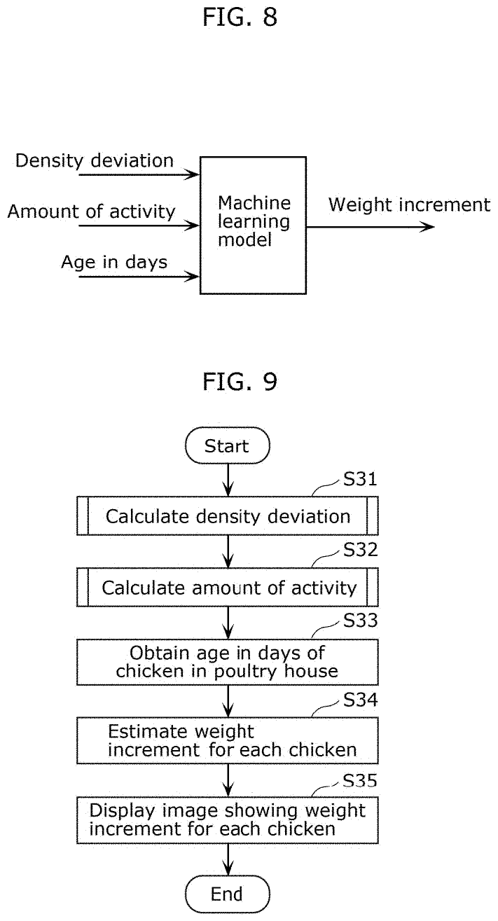

As described above, the density deviation and the amount of activity indicate the feed consumption state of chickens in poultry house 100, and therefore it is estimated that the feed consumption state is closely related to a weight increment for each chicken. Estimator 32b can estimate a weight for each chicken using (i) as input data, the age in days of chickens, the density deviation at the age in days, and the amount of activity at the age in days, and (ii) machine learning model created based on machine learning using, as training data, a measured value of a weight increment for each chicken at the age in days. FIG. 8 is a diagram schematically illustrating a machine learning model used for estimating a weight for each chicken.

As illustrated in FIG. 8, such a machine learning model can output an estimated value of a weight increment for each chicken, using, as input data, the age in days of chickens, the density deviation at the age in days, and the amount of activity at the age in days. Note that the input data may include, for example, seasonal information (year, month, and day information) and environmental information (e.g., temperature information and humidity information) on the inside of poultry house 100, other than the age in days of chickens, the density deviation at the age in days, and the amount of activity at the age in days.

Note that a machine learning model used in one poultry house 100 is created based on machine learning that uses data obtained in this particular poultry house 100. That is, a machine learning model is customized for each of poultry houses 100. However, a machine learning model created based on machine learning that uses data obtained in one poultry house 100 may be used in other poultry houses 100. In this case, output data outputted from the machine learning model may be adjusted, for example.

### [Operation for Estimating Weight]

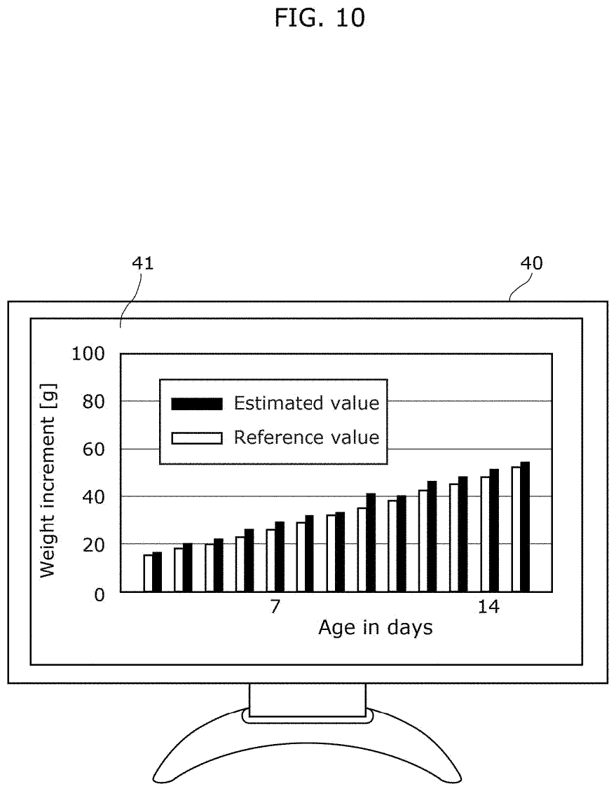

Operation for estimating a weight for each chicken using such a machine learning model will be described. FIG. 9 is a flowchart illustrating operation for estimating a weight for each chicken. First, calculator 32a calculates a density deviation (S31). The method for calculating the density deviation is as described with reference to FIG. 3. Next, calculator 32a calculates an amount of activity (S32). The method for calculating the amount of activity is as described with reference to FIG. 6.

Next, estimator 32b obtains the age in days of chickens in poultry house 100 at the time at which the image used for the calculation of the density deviation and the amount of activity is captured (S33). The age in days of the chickens is inputted to inputter 34 by a manager, etc. of poultry house 100, for example. The age in days of the chickens may be measured (counted) by estimator 32b.

Next, estimator 32b estimates a weight increment for each chicken (S34). Estimator 32b can obtain an estimated value of a weight increment for each chicken at the age in days by inputting, in the machine learning model illustrated in FIG. 8, the density deviation calculated in step S31, the amount of activity calculated in step S32, and the age in days of the chickens obtained in step S33. Note that an estimated value of a weight increment for each chicken here is an estimated value of a weight increment in one chicken (in other words, the average weight increment), for example.

Next, estimator 32b generates image information based on the estimated value of the weight increment for each chicken, and display 41 displays, based on the image information, an image showing the estimated value of the weight increment for each chicken (S35). FIG. 10 is a diagram illustrating an example of a display of estimated values of weight increments for each chicken.

Reference weights are determined for chickens raised in poultry house 100. The reference weights are, for example, ideal weights (target weights) for respective ages in days which are provided by a provider of chicks, and weight information indicating such reference weights for respective ages in days is prestored in storage 33 as weight information. Note that the reference weights may be, for example, average weights for respective ages in days of chickens raised in poultry house 100 (measured average weights of chickens raised in poultry house 100) in the past.

In the example shown in FIG. 10, display 41 displays, for comparison, reference values (target values) of weight increments based on such weight information, in addition to estimated values of weight increments. As described, displaying of reference values of weight increments in addition to estimated values of weight increments for comparison makes it possible to readily grasp the favorable growth or the unfavorable growth of chickens from degrees of differences between the estimated values and the reference values.

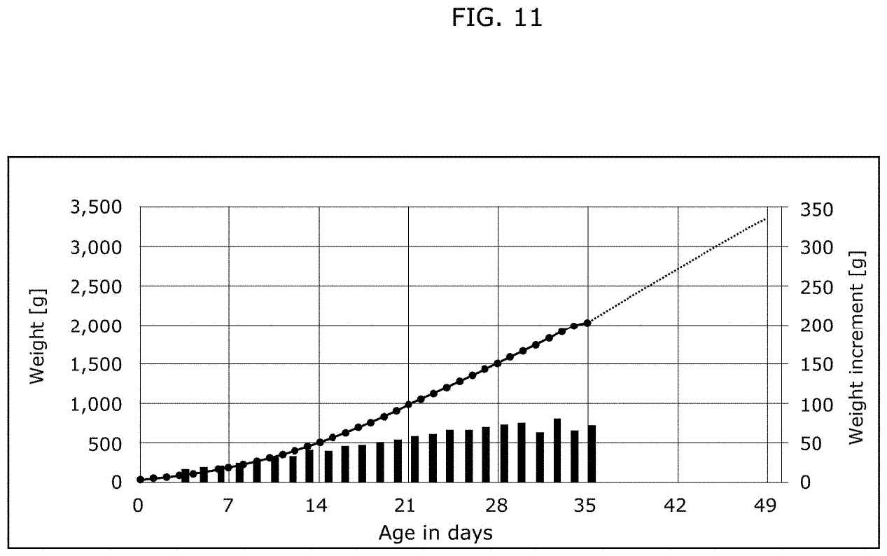

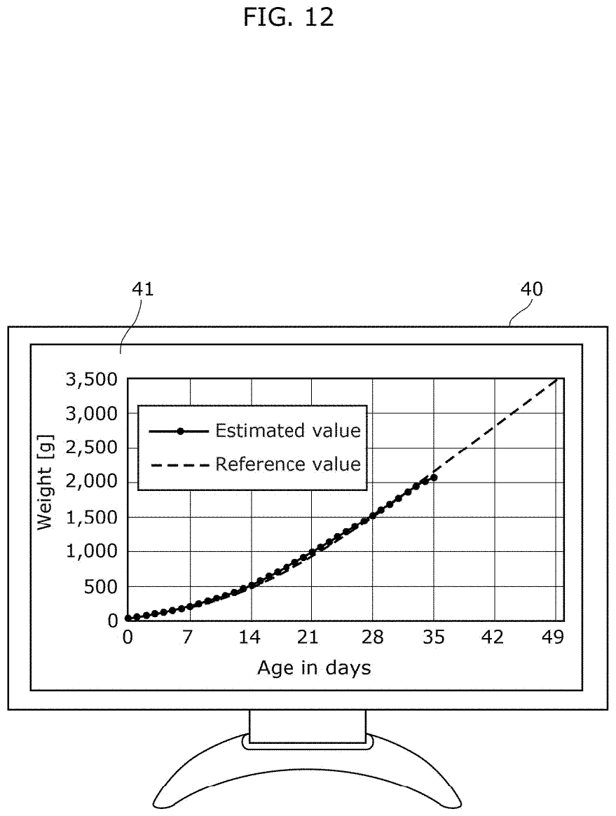

In addition, estimator 32b can also estimate the present weight for each chicken by adding up estimated values of daily weight increments. FIG. 11 is a graph (line graph) illustrating a progression of estimated values of weights for each chicken. FIG. 11 also illustrates estimated values (bar graph) of weight increments for each chicken. Note that the estimated values of weights for each chicken here are estimated values of weights of one chicken (in other words, the average weight for each chicken), for example.

In addition, estimator 32b can estimate (predict) a future weight for each chicken by seeking an approximate curve (dotted line in FIG. 11) from a progression of estimated values of weights (in other words, estimated values of a plurality of weights). For example, estimator 32b can estimate the weight for each chicken in poultry house 100 at the time of a shipment (e.g., 49th day).

If the weight for each chicken at the time of a shipment is estimated before the time of the shipment as described above, it is possible to grasp the workload for a shipment in advance and to readily get hold of staff members.

Note that display 41 may display estimated values of the above-described weights. Display 41 may display, in this case also, reference values (target values) of weights based the weight information, in addition to estimated values of weights for comparison. FIG. 12 is a diagram illustrating an example of a display of estimated values of weights for each chicken.

### [Calculation of Feed Conversion Rate and Production Score]

Calculator 32a may further calculate, based on an estimated weight increment, a parameter indicating productivity in poultry house 100, such as the feed conversion rate (FCR). FCR is an indicator showing how many kilograms of feed are required for one kilogram of weight increment, and is calculated based on the following formula: FCR=an amount of feed consumption (kg)/a weight increment (kg).

In this case, when a manager, etc. of poultry house 100 inputs, for example, an amount of feed consumption to inputter 34, calculator 32a can calculate FCR by dividing the inputted amount of feed consumption by a weight increment estimated by estimator 32b.

In addition, calculator 32a may further calculate the production score (PS), based on the estimated weight at the time of a shipment. PS is an indicator for a measurement of a physical production level, and is calculated based on the following formula: PS=(a weight at the time of a shipment×a growth rate/the shipment age in days/FCR)×100. Note that the growth rate is, in other words, a mortality rate of chickens, and is calculated by the following formula: mortality rate=the number of chickens at the time of a shipment/the number of chickens at the beginning of raising the chickens.

In this case, when a manager, etc. of poultry house 100 inputs, for example, a shipment age in days and a growth rate to inputter 34, calculator 32a can calculate PS by using the weight at the time of a shipment which is estimated by estimator 32b and FCR calculated by calculator 32a, in addition to the inputted information.

As has been described above, weight estimation system 10 can calculate parameters indicating productivity based on an estimated weight. Note that calculated parameters (FCR and PS) indicating productivity may be displayed on display 41.

### [Variation]

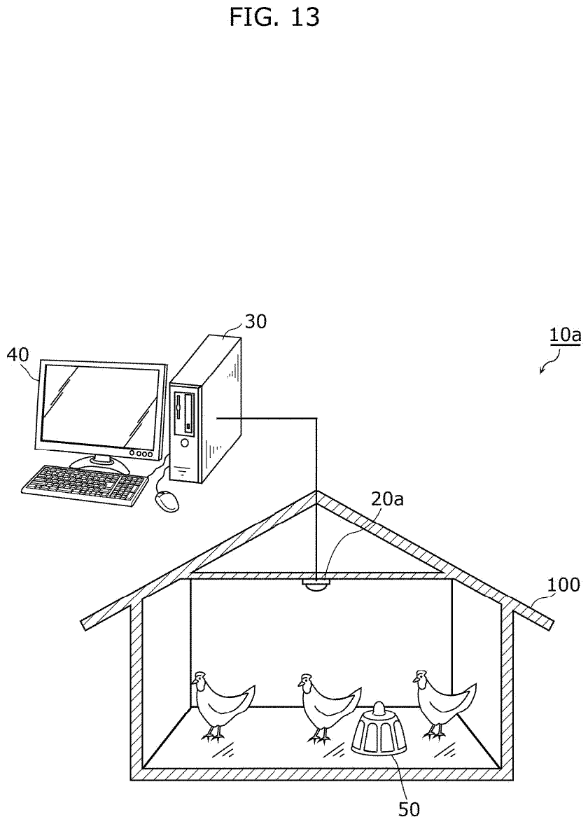

An image capturing device provided in poultry house 100 may be a fisheye camera. FIG. 13 is a diagram illustrating an overview of a weight estimation system according to a variation.

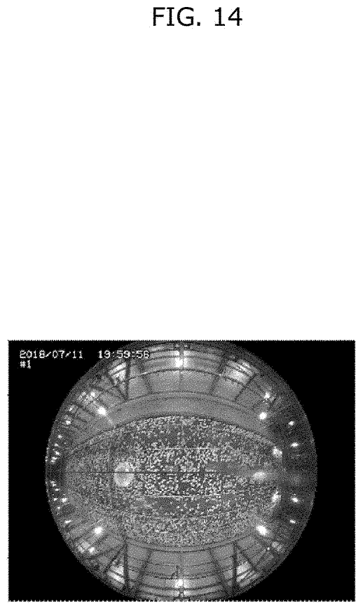

Image capturing device 20a included in weight estimation system 10a illustrated in FIG. 13 is a fisheye camera. Image capturing device 20a as described above is implemented by, for example, an image capturer (not illustrated) of image capturing device 20a including a fisheye lens. Image capturing device 20a is provided on a ceiling of poultry house 100 to capture an inside of poultry house 100 from above. FIG. 14 is a diagram illustrating an example of a moving image of the inside of poultry house 100 which is captured by image capturing device 20a.

When the inside of poultry house 100 is captured diagonally from above, as in weight estimation system 10, chickens present in a location distant from image capturing device 20 in an image are shown as if the chickens are densely packed together. Accordingly, it may be necessary to find an ingenious way to exclude such a region when a parameter such as a density deviation is calculated as described above.

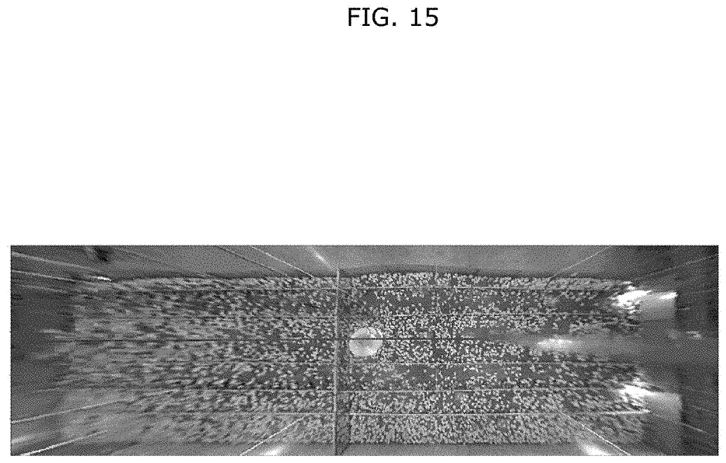

In contrast, by performing image processing (more specifically, projective transformation processing that converts an equidistant projection image into a central projection image), a moving image captured by a fisheye camera as shown in FIG. 14 is readily corrected to an image in which the entirety of the inside of poultry house 100 is captured from above as shown in FIG. 14. That is, image capturing device 20a can readily capture the entirety of the inside of poultry house 100. FIG. 15 is a diagram illustrating an example of an image obtained by correcting (i.e., performing projective transformation processing on) an image of the inside of poultry house 100 which is captured by image capturing device 20a. As has been described, it can be said that image capturing device 20a is suitable for generation of images for monitoring purposes and for calculation of the parameters using the images for monitoring purposes.

Note that when image capturing device 20a is used for generation of an image for monitoring purposes, projective transformation processing may be performed on the image before the image is converted into a black-and-white image, or the image may be converted into a black-and-white image before projective transformation processing is performed on the image.

### [Advantageous Effects, Etc.]

As has been described above, weight estimation system 10 includes: image capturer 21 that captures an image of an inside of poultry house 100; calculator 32a that calculates a flocking behavior feature quantity of chickens in poultry house 100 by performing image processing on the image captured by image capturer 21; and estimator 32b that estimates a weight for each chicken in poultry house 100, based on the flocking behavior feature quantity calculated.

Weight estimation system 10 as described above can readily estimate a weight for each chicken in poultry house 100 by performing image processing.

In addition, for example, calculator 32a calculates the flocking behavior feature quantity by performing image processing on the image which is captured by image capturer 21 and in which at least one feeder 50 provided in poultry house 100 is present.

Weight estimation system 10 as described above can accurately estimate a weight for each chicken in poultry house 100 by performing image processing on an image that is more deeply related to the feed consumption state.

In addition, for example, the flocking behavior feature quantity comprises a plurality of flocking behavior feature quantities. Calculator 32a calculates (a) for each of subregions obtained by dividing a particular region that is at least part of the image, a proportion of the subregion estimated to be occupied by at least one chicken, and calculates, as a flocking behavior feature quantity among the plurality of flocking behavior feature quantities, a variation in the proportions, and (b) as a flocking behavior feature quantity among the plurality of flocking behavior feature quantities, an amount of activity of the chickens in poultry house 100 by performing the image processing on the particular region. Estimator 32b estimates the weight for each chicken in poultry house 100 based on the variation in the proportions and the amount of activity.

Weight estimation system 10 as described above can accurately estimate a weight for each chicken in poultry house 100 by using a density deviation and an amount of activity each of which is a flocking behavior feature quantity indicating a feed consumption state. Note that estimator 32b may estimate a weight for each chicken in poultry house 100 using at least one of the density deviation and the amount of activity, or may estimate a weight for each chicken in poultry house 100 using a flocking behavior feature quantity other than the density deviation and the amount of activity.

In addition, for example, estimator 32b estimates, based on the flocking behavior feature quantity, weight increments for respective ages in days of the chickens in poultry house 100.

Weight estimation system 10 as described above can estimate weight increments for respective ages in days of the chickens in poultry house 100.

In addition, for example, calculator 32a further calculates, based on the weight estimated, at least one of a feed conversion rate and a production score.

Weight estimation system 10 as described above can calculate at least one of the feed conversion rate and the production score.

In addition, for example, estimator 32b estimates a weight for each chicken in poultry house 100 at a time of a shipment of the chickens, based on the flocking behavior feature quantity calculated from the image captured before the time of the shipment of the chickens in poultry house 100.

Weight estimation system 10 as described above can estimate a weight for each chicken in poultry house 100 at the time of a shipment of the chickens. If a weight for each chicken at the time of a shipment is estimated before the time of the shipment, it is possible to grasp the workload for the shipment in advance and to readily get hold of staff members for the shipment work.

In addition, for example, weight estimation system 10 further includes display 41 that displays the weight estimated and a predetermined reference weight for comparison.

Weight estimation system 10 as described above can display an estimated weight and a predetermined reference weight for comparison. If the predetermined reference weight is displayed in addition to the estimated weight for comparison, it is possible to grasp the favorable growth or the unfavorable growth of chickens from a degree of a difference between the estimated weight and the reference weight.

In addition, a weight estimation method includes: capturing an image of an inside of poultry house 100; calculating a flocking behavior feature quantity of chickens in poultry house 100 by performing image processing on the image; and estimating a weight for each chicken in poultry house 100, based on the flocking behavior feature quantity calculated.

The weight estimation method as described above can readily estimate a weight for each chicken in poultry house 100 by performing image processing.

### Other Embodiments

The weight estimation systems according to the embodiments are hereinbefore described, but the present invention is not limited to the above embodiments.

For example, the present invention may be implemented as a system intended for diurnal poultry. Other than chickens, diurnal poultry includes, for example, ducks, turkeys, or guinea fowls.

Moreover, although the weight estimation systems each are implemented as a system including a plurality of devices in the above embodiments, each weight estimation system may be implemented as a single device or as a client-server system.

Furthermore, the assignment of elements included in each weight estimation system to the plurality of devices is an example. For example, an element included in a device may be included in another device. An information terminal may include a display instead of the display device, and the display device may be omitted, for example.

In addition, these comprehensive or concrete embodiments may be implemented by a device, a system, a method, an integrated circuit, a computer program, or a computer-readable recording medium such as a CD-ROM, or by any optional combination of devices, systems, methods, integrated circuits, computer programs, or computer-readable recording media. For example, the present invention may be implemented as a weight estimation method, as a program for a computer to execute the weight estimation method, or as a non-transitory computer-readable recording medium on which the program is recorded.

Moreover, in the above embodiments, a process performed by a particular processor may be performed by another processor. In addition, orders of processes performed in operation of the above-described weight estimation systems are examples. The orders of processes may be changed or may be performed in parallel.

Furthermore, in the above embodiments, elements such as an information processor may be implemented by executing a software program suitable for each element. Each element may be implemented as a program executor such as a central processing unit (CPU) or a processor or the like reading and executing a software program stored in a storage medium such as a hard disk or a semiconductor memory.

In addition, each element such as an information processor may be implemented by a hardware product. Specifically, each element may be implemented by a circuit or an integrated circuit. These circuits may constitute a single circuit as a whole or may be individual circuits. Furthermore, each circuit may be a general-purpose circuit or a dedicate circuit.

The present invention also encompasses: embodiments achieved by applying various modifications conceivable to those skilled in the art to each embodiment; and embodiments achieved by optionally combining the elements and the functions of each embodiment without departing from the essence of the present invention.

### REFERENCE SIGNS LIST

10, 10a weight estimation system
21 image capturer
32a calculator
32b estimator
41 display
50 feeder
100 poultry house
a subregion
A, A1, A2 particular region

1. A weight estimation system comprising:
an image capturer that captures an image of an inside of a poultry house;
a calculator that calculates a flocking behavior feature quantity of chickens in the poultry house by performing image processing on the image captured by the image capturer; and
an estimator that estimates a weight for each chicken in the poultry house, based on the flocking behavior feature quantity calculated.

2. The weight estimation system according to claim 1, wherein
the calculator calculates the flocking behavior feature quantity by performing image processing on the image which is captured by the image capturer and in which a feeder provided in the poultry house is present.

3. The weight estimation system according to claim 1, wherein
the flocking behavior feature quantity comprises a plurality of flocking behavior feature quantities,
the calculator calculates (a) for each of subregions obtained by dividing a particular region that is at least part of the image, a proportion of the subregion estimated to be occupied by at least one chicken, and calculates, as a flocking behavior feature quantity among the plurality of flocking behavior feature quantities, a variation in the proportions, and (b) as a flocking behavior feature quantity among the plurality of flocking behavior feature quantities, an amount of activity of the chickens in the poultry house by performing the image processing on the particular region, and
the estimator estimates the weight for each chicken in the poultry house based on the variation in the proportions and the amount of activity.

4. The weight estimation system according to claim 1, wherein
the estimator estimates, based on the flocking behavior feature quantity, weight increments for respective ages in days of the chickens in the poultry house.

5. The weight estimation system according to claim 1, wherein
the calculator further calculates, based on the weight estimated, at least one of a feed conversion rate and a production score.

6. The weight estimation system according to claim 1, wherein
the estimator estimates a weight for each chicken in the poultry house at a time of a shipment of the chickens, based on the flocking behavior feature quantity calculated from the image captured before the time of the shipment of the chickens in the poultry house.

7. The weight estimation system according to claim 1, further comprising:
a display that displays the weight estimated and a predetermined reference weight for comparison.

8. A weight estimation method comprising:
capturing an image of an inside of a poultry house;
calculating a flocking behavior feature quantity of chickens in the poultry house by performing image processing on the image; and
estimating a weight for each chicken in the poultry house, based on the flocking behavior feature quantity calculated.

9. A non-transitory computer-readable recording medium for use in a computer, the recording medium having a computer program recorded thereon for causing the computer to execute the weight estimation method according to claim 8.
